(19) United States
(12) Patent Application Publication
(10) Pub. No.: US 2007/0090611 A1
(43) Pub. Date: Apr. 26, 2007

(54) Hydraulic workholding assembly

(75) Inventors: Daniel P. Soroka, Horseheads, NY (US); Neal DesRuisseaux, Coatesville, PA (US); Joseph Colvin, Horseheads, NY (US)

Correspondence Address: PILLSBURY WINTHROP SHAW PITTMAN, LLP, P.O. BOX 10500, MCLEAN, VA, 22102, US

(73) Assignee: Hardinge, Inc., Elmira, NY (US)

(21) Appl. No.: 11/252,242

(22) Filed: Oct. 18, 2005

(51) Int. Cl. B23B 31/30

(52) U.S. Cl. 279/4.12

(57) ABSTRACT

A workholding assembly for releasably holding a work piece includes a master variable-volume fluid chamber disposed between a machine and the machine's axially-movable draw bar such that the workholding assembly converts the mechanical axial force/movement of the draw bar into fluid pressure/fluid flow. The resulting fluid pressure operates a fluid-driven gripping assembly such as a radial-piston-based hydraulic collet assembly or a diaphragm-based hydraulic gripping assembly. The hydraulic collet assembly may be a quick-change assembly that enables an operator to quickly and easily change between differently sized or shaped collets.

### BACKGROUND OF THE INVENTION

1. Field of the Invention

This invention relates to the use of hydraulic pressure to grip a work piece within a workholding assembly.

2. Description of Related Art

A conventional workholding assembly typically includes a gripping assembly (e.g., a collet assembly or chuck assembly) that uses gripping jaws that synchronously move radially inward and outward equal distances. If such a conventional gripping assembly grips the outside diameter of an out-of-round work piece, the gripping assembly will tend to deform the work piece into a round shape because the gripping jaw that abuts a portion of the work piece with a larger diameter will apply a greater force to that portion of the work piece. The deformed work piece, such as a bearing race, is machined round while in its deformed shape, but elastically rebounds into an out-of-round position when released from a conventional gripping assembly.

As shown in U.S. Pat. No. 6,123,341, conventional hydraulic collet assemblies utilize a plurality of circumferentially-spaced, radially-oriented piston/cylinders to clamp a work piece to the assembly. If the piston/cylinders are fluidly interconnected, each piston/cylinder applies an equal force to the work piece. As explained in U.S. Pat. No. 6,354,606, fluidly interconnected piston/cylinders are well suited to holding irregularly shaped work pieces because the piston/cylinders avoid imposing large forces on the widest part of the work piece. Unfortunately, conventional hydraulic collet assemblies required complex centering mechanisms (e.g., additional centering pistons) to center the work pieces before gripping them.

Conventional hydraulic collet assemblies utilize externally disposed pressurized fluid sources that must be fluidly connected to the piston/cylinders. If the collet rotates in the machine in which it is used, hydraulic passageways must extend along the axis of rotation from the pressurized fluid source to the piston/cylinder and must include rotatable fluid joints.

### SUMMARY OF THE INVENTION

Accordingly, one aspect of one or more embodiments of this invention provides an improved hydraulic workholding assembly.

Another aspect of one or more embodiments of this invention provides a hydraulic pressure generator for use with a hydraulic collet, wherein the generator relies on a mechanical connection to a draw bar to provide the hydraulic pressure. The mechanical connection eliminates the need for a separate hydraulic power supply or hydraulic passages that extend from an underlying machine into the hydraulic workholding assembly.

Another aspect of one or more embodiments of this invention provides a hydraulic workholding assembly that uses a conventional, axially-movable draw bar to provide hydraulic pressure.

Another aspect of one or more embodiments of this invention provides a gripping assembly with a plurality of gripping jaws that move independently to conform to irregularities in the work piece while applying constant gripping force to the work piece.

Another aspect of one or more embodiments of this invention provides a hydraulic gripping assembly that includes a simple mechanism to initially center the work piece in the gripping assembly.

Another aspect of one or more embodiments of this invention provides a quick change hydraulic diaphragm gripping assembly that enables a diaphragm to be replaced without accessing or disturbing the hydraulic fluid in the gripping assembly.

Another aspect of one or more embodiments of the present invention provides a workholding assembly for releasably holding a work piece. The assembly includes a variable-volume fluid chamber constructed and arranged to fluidly connect to a fluid-driven gripping assembly. The variable-volume fluid chamber is constructed and shaped to detachably mount to an axially-movable draw bar of a machine such that axial movement of the draw bar in a predetermined direction reduces a volume of the variable-volume fluid chamber.

According to a further aspect of one or more of these embodiments, the workholding assembly includes an axially-movable element having a threaded portion that is constructed and arranged to engage a mating threaded portion of the axially-movable draw bar. Axial movement of the axially-movable element in the predetermined direction reduces a volume of the variable-volume fluid chamber.

According to a further aspect of one or more of these embodiments, the workholding assembly includes a fluid-driven gripping assembly fluidly connected to the variable-volume fluid chamber such that reduction of the volume of the variable-volume fluid chamber operates the fluid-driven gripping assembly. The workholding assembly may also include a machine, and a draw bar that is selectively axially movable relative to the machine. The variable-volume fluid chamber is positioned relative to the machine and the draw bar such that axial movement of the draw bar in the predetermined direction reduces the volume of the variable-volume fluid chamber. The fluid-driven gripping assembly may include a fluid-driven collet assembly that includes a collet having a collet axis that is coaxial with an axis of the draw bar. The draw bar may include a threaded portion that threadingly engages the threaded portion of the axially movable element.

According to a further aspect of one or more of these embodiments, the workholding assembly includes a master cylinder and a master piston slidably engaged with the master cylinder to define the variable-volume fluid chamber. The master piston and master cylinder have a master axis. One of the master cylinder and the master piston is constructed and arranged to mount to the machine. The other of the master cylinder and the master piston is constructed and arranged to detachably mount to the draw bar.

The workholding assembly may also include a fluid-driven gripping assembly mounted to the one of the cylinder and the piston, wherein the variable-volume fluid chamber fluidly connects to the fluid-driven gripping assembly such that axial movement of the master piston relative to the master cylinder operates the fluid-driven gripping assembly.

According to a further aspect of one or more of these embodiments, the fluid-driven gripping assembly comprises a housing, and at least one slave variable-volume fluid chamber supported by the housing and fluidly connected to the variable-volume fluid chamber. The at least one slave variable-volume fluid chamber may include a plurality of circumferentially-spaced slave piston/cylinders supported by the housing. Each of the slave piston/cylinders has a slave cylinder axis that is perpendicular to the master cylinder axis. Each of the slave piston/cylinders has a slave chamber that fluidly connects to the variable-volume fluid chamber. A cross-sectional area of each slave piston/cylinder may be smaller than a cross-sectional area of the master cylinder such that a force generated by each slave piston/cylinder is smaller than a force that the draw bar applies to the other of the master cylinder and the master piston.

According to a further aspect of one or more of these embodiments, the fluid-driven gripping assembly includes a fluid-driven collet assembly that includes a collet mounted to the housing. The collet has a plurality of gripping jaws. Each gripping jaw aligns with a corresponding one of the plurality of slave piston/cylinders such that operation of the slave/piston cylinders moves the gripping jaws. The plurality of gripping jaws may be biased toward a released position in which the gripping jaws form a work piece abutting surface that is concentric with the axis. The work piece abutting surface may be shaped to have a tight tolerance with the work piece such that inserting the work piece into the released-position collet tends to center the work piece in the collet.

The fluid-driven collet assembly may be constructed and shaped to grip an outside diameter of a work piece or an inside diameter of a work piece. The fluid-driven gripping assembly may be a fluid-driven diaphragm gripping assembly.

Another aspect of one or more embodiments of this invention provides a fluid-driven collet assembly that includes a housing and a plurality of circumferentially-spaced piston/cylinders supported by the housing. Each of the piston/cylinders has a cylinder axis that is perpendicular to an axis of the fluid-driven collet assembly. Each of the piston/cylinders has a chamber that constructed and shaped to fluidly connect to a pressurized fluid source. The assembly also includes a collet mounted to the housing. The collet has a plurality of gripping jaws. Each gripping jaw aligns with a corresponding one of the plurality of piston/cylinders such that operation of the piston/cylinders moves the gripping jaws. The plurality of gripping jaws may be integrally formed with each other.

Another aspect of one or more embodiments of this invention provides a fluid-driven diaphragm gripping assembly that includes a housing having a fluid chamber formed therein. The fluid chamber is constructed and shaped to fluidly connect to a source of pressurized fluid. The gripping assembly also includes an actuating element sealingly connecting to the fluid chamber and defining a portion of the fluid chamber, at least a portion of the actuating element being axially movable in response to pressurization of the fluid chamber. The gripping assembly also includes a diaphragm mounted to the housing and operatively connected to the actuating element such that axial movement of the portion of the actuating element deforms the diaphragm. The gripping assembly also includes a plurality of gripping jaws mounted to the diaphragm. Deformation of the diaphragm radially separates the gripping jaws from each other.

According to a further aspect of one or more of these embodiments, the diaphragm and actuating element may be separated from each other to allow the diaphragm to be detached from the gripping assembly without unsealing the actuating element from the fluid chamber.

According to a further aspect of one or more of these embodiments, the diaphragm is mounted to the housing via at least one fastener, and the diaphragm may be detached from the housing without completely detaching the at least one fastener from the housing.

Another aspect of one or more embodiments of this invention provides a method of operating a fluid-driven workholding assembly that includes a variable-volume fluid chamber and a fluid-driven gripping assembly fluidly connected to the variable-volume fluid chamber. The method includes detachably mounting the fluid-driven workholding assembly to a machine, the machine having a draw bar that is axially movable relative to the machine along a draw bar axis. The method also includes axially moving the draw bar to compress the variable-volume fluid chamber. The method also includes transferring fluid pressure in the variable-volume fluid chamber to the fluid-driven gripping assembly, thereby operating the fluid-driven gripping assembly. The fluid-driven gripping assembly may have an axis that is coaxial to the draw bar axis. Transferring fluid pressure may include applying fluid pressure in the variable-volume fluid chamber to the fluid-driven gripping assembly to close the fluid-driven gripping assembly and grip a work piece.

Additional and/or alternative advantages and salient features of the invention will become apparent from the following detailed description, which, taken in conjunction with the annexed drawings, disclose preferred embodiments of the invention.

### BRIEF DESCRIPTION OF THE DRAWINGS

Referring now to the drawings which from a part of this original disclosure:

FIG. 1 is a perspective cut-away view of an outside-diameter-gripping hydraulic workholding assembly according to an embodiment of the present invention;

FIG. 2 is a cross-sectional view of the hydraulic workholding assembly of FIG. 1;

FIG. 3 is a perspective view of the hydraulic workholding assembly of FIG. 1;

FIG. 4 is an exploded side view of an inside-diameter-gripping hydraulic workholding assembly according to an alternative embodiment of the present invention;

FIGS. 5A-5D illustrate the sequential process of mounting a collet to the hydraulic workholding assembly of FIG. 4;

FIG. 6 is a cross-sectional view of a hydraulic collet closer that can be used in connection with one or more embodiments of the present invention;

FIG. 7 is an enlarged view of a portion of the hydraulic workholding assembly of FIG. 4;

FIG. 8 is a side view of a piston of the hydraulic workholding assembly of FIG. 4;

FIG. 9 is an exploded view of a diaphragm gripping assembly for use in a hydraulic workholding assembly according to an embodiment of the present invention;

FIG. 10 is a front view of the diaphragm gripping assembly in FIG. 9;

FIG. 11 is a side partial-cross-sectional view of a hydraulic workholding assembly with the diaphragm gripping assembly of FIG. 9 according to an alternative embodiment of the present invention; and

FIG. 12 is a side cross-sectional view of a multi-piece inside-diameter-gripping collet for use with the assembly illustrated in FIG. 4.

### DETAILED DESCRIPTION OF PREFERRED EMBODIMENTS

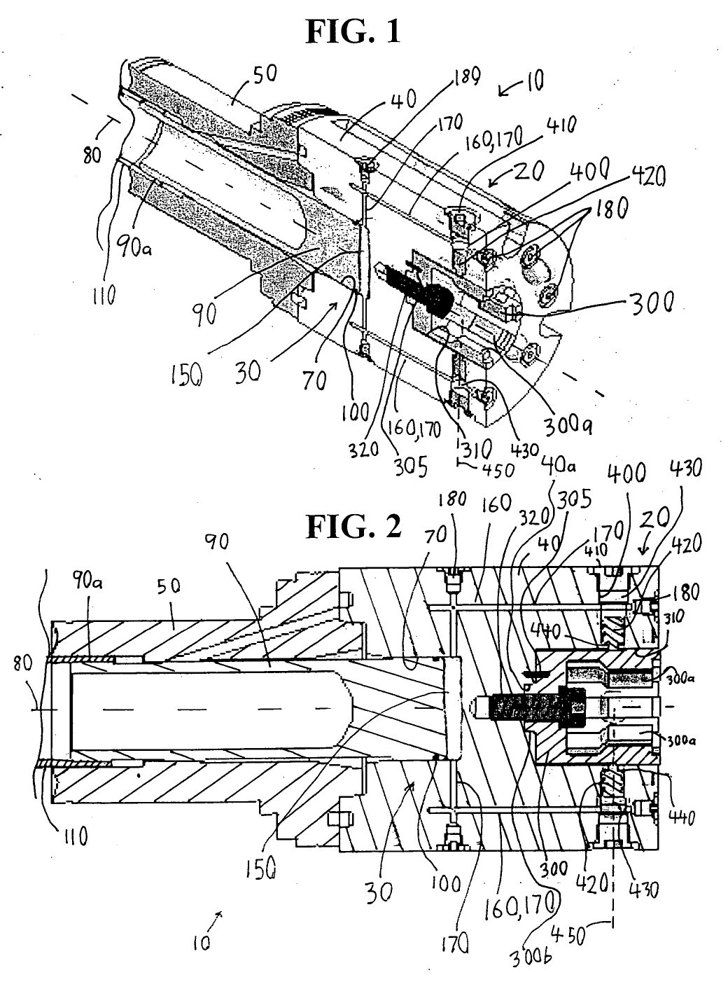

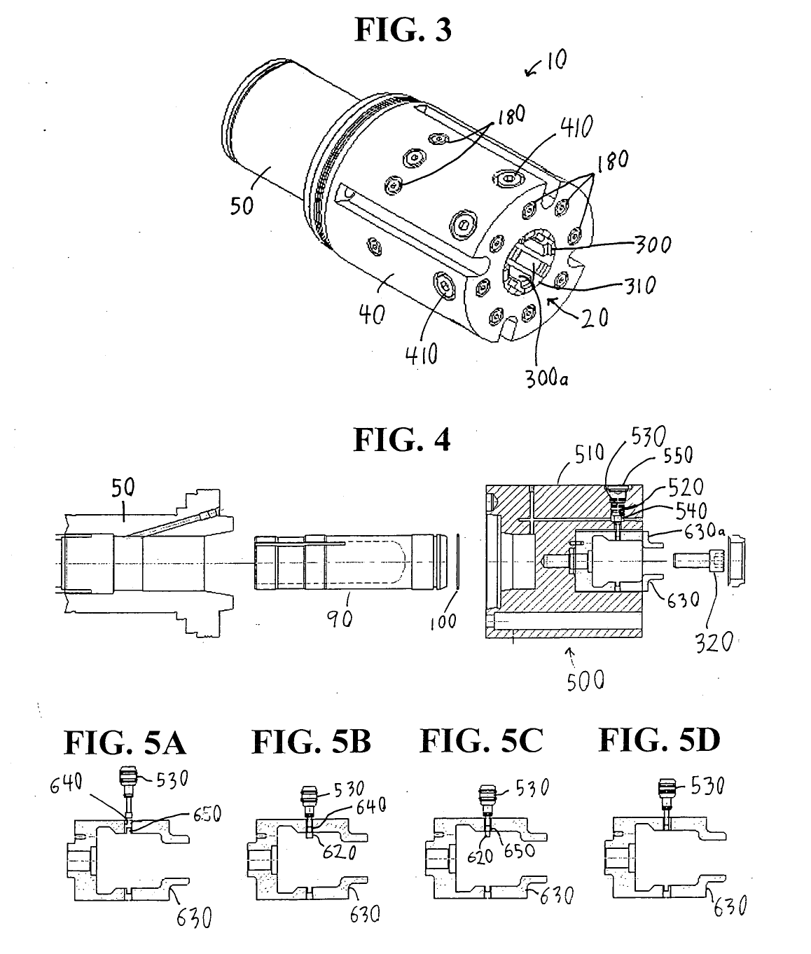

FIGS. 1-3 illustrate a hydraulic workholding assembly 10 according to an embodiment of the present invention. The assembly 10 includes a hydraulic collet assembly 20 that is operated via a hydraulic pressure generator 30.

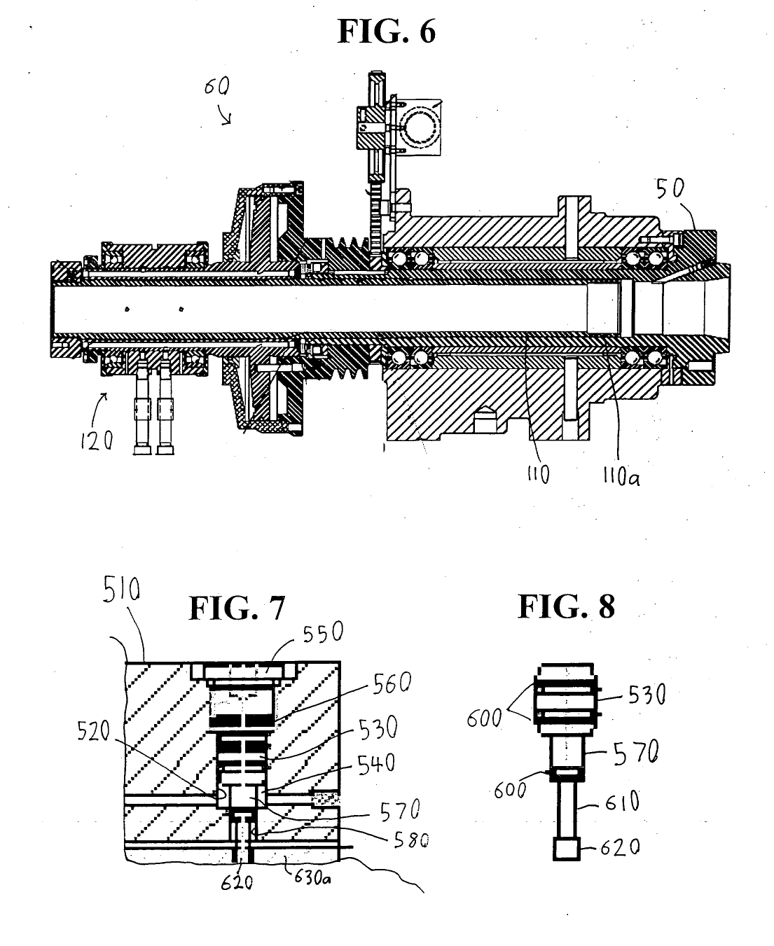

Hereinafter, the hydraulic pressure generator 30 is described with reference to FIGS. 1, 2, and 6. As shown in FIG. 1, the assembly 10 includes a housing 40 that securely mounts to a spindle 50 of an underlying machine 60 (see FIG. 6). As shown in FIGS. 1-2, a hydraulic cylinder 70 is formed in the housing 40 and is concentric with an axis 80 of the spindle 50.

As shown in FIGS. 1 and 2, a piston 90 slidably extends through a bore in the spindle 50 and into the cylinder 70. A sealing O-ring 100 extends around the outer circumferential surface of the piston 90 to create a sealed connection between the piston 90 and cylinder 70. A rearward portion 90a of the piston 90 is externally threaded and threadingly engages an internally threaded portion 110a of an axially-movable draw bar 110 of the underlying machine 60 (see FIG. 6). However, the piston 90 could alternatively mount to the draw bar 110 in any other suitable manner for axial movement with the draw bar 110 along the axis 80 relative to the machine 60 and spindle 50. The connection between the draw bar 110 and piston 90 is preferably detachable so that hydraulic workholding assembly 10 may be attached to and detached from the draw bar 110 and underlying machine 60 (e.g., internal or external threaded connection, bayonet-style lock, simple compressive contact that allows the draw bar 110 to separate from the piston 90 if the draw bar 110 is moved rearwardly but allows the draw bar 110 to transfer compressive force to the piston 90, etc.). The detachable connection facilitates use of the hydraulic workholding assembly 10 with conventional machines that have conventional draw bars. However, the draw bar 110 and piston 90 may alternatively be permanently attached to each other without deviating from the scope of the present invention (e.g., integral formation (e.g., integrally molded, extruded, cast, etc.), welded connection, etc.).

The illustrated draw bar 110 is hydraulically operated such that selective application of hydraulic pressure to a draw bar closer assembly 120 forces the draw bar 110 to move along the axis 80 forward (to the right as shown in FIG. 6) or backward (to the left as shown in FIG. 6). However, any other suitable mechanism may be used to drive the draw bar 110 (e.g., linear electric motor, pneumatic closer, hand-operated draw-bar (e.g., rack-and-pinion), etc.).

Axial movement of the draw bar 110 axially moves the piston 90, which changes the volume of a hydraulic-fluid-filled chamber 150 defined between the piston 90 and cylinder 70. A series of fluid passages 160 operatively extend between the chamber 150 and the hydraulic collet assembly 20 to provide selective hydraulic pressure to the hydraulic collet assembly 20. As shown in FIGS. 1-3, the fluid passages 160 are formed via a plurality of bores 170 or other channels in the housing 40. Caps 180 seal external ends of the bores 170. According to an alternative embodiment of the present invention, the fluid passages 160 each comprise single straight bores that each extend from the chamber 150 to a corresponding chamber 430 without the use of caps 180.

An upwardly facing one of the caps 180 may be removed to fill the assembly 10 with hydraulic fluid. Alternatively, a separate fill tube and cap may fluidly connect to the hydraulic circuit within the assembly 10 for adding and removing hydraulic fluid. One of the bores 170 may be widened relative to the other to facilitate filling and emptying of hydraulic fluid from the assembly 10.

While the illustrated hydraulic pressure generator 30 utilizes a draw-bar-driven piston/cylinder, hydraulic pressure generators according to other embodiments of the present invention may comprise any other suitable hydraulic pressure generator (e.g., external hydraulic pump). Alternatively, the piston/cylinder 90/70 may be replaced by another suitable draw-bar-driven mechanism. For example, a master fluid chamber may be defined within a variable volume chamber that is formed by, for example, a flexible bladder or a flexible diaphragm. The draw bar 110 could directly or indirectly compress the variable volume chamber so as to pressurize the master fluid chamber and reduce its volume.

In the illustrated embodiment, the piston 90 axially moves with the draw bar 110, while the cylinder 70 remains axially fixed to the spindle 50 and underlying machine 60. However, the relative positions of the piston 90 and cylinder 70 could be switched without deviating from the scope of the present invention. In such an embodiment, the fluid passage 160 could extend into the chamber through the fixed-position piston.

Hereinafter, the hydraulic collet assembly 20 is described with reference to FIGS. 1 and 2. A collet 300 extends into a bore 310 in a forward end of the housing 40. As shown in FIG. 2, a rearward end of the collet 300 includes a centering protrusion 300b that mates with a corresponding bore 40a in the housing 40 to center the collet 300 in the housing 40. A bolt 320 secures the collet 300 to the housing 40 and centers the collet 300 in the bore 40a so that the collet 300 is coaxial with the axis 80. An eccentrically disposed pin 305 may extend between bores in the housing 40 and collet 300 to fix a rotational orientation of the collet 300 relative to the housing 40. The collet 300 is designed to grip an outside diameter of a work piece having a particular outside diameter or range of outside diameters. A variety of differently sized collets 300 may be provided for use in gripping work pieces with different outside diameters.

The collet 300 includes a plurality of gripping jaws 300a that are circumferentially spaced from each other by slots formed in the collet 300. The illustrated collet 300 includes eight gripping jaws 300a, but greater or fewer jaws could be provided without deviating from the scope of the present invention. The collet 300 is shaped such that the gripping jaws 300a are elastically biased radially outwardly toward an open/released position of the collet 300. For example, an outside diameter of the collet 300 at the axial position of the gripping jaws 300a may be slightly larger than the bore 310 so that insertion of the collet 300 into the bore 310 elastically bends the gripping jaws 300a radially inwardly, which causes the gripping jaws 300a to exert an outward radial force. Alternatively, the outside diameter of the collet 300 may be equal to or smaller than the diameter of the bore 310 such that the gripping jaws 300a only apply an outwardly biased force when the hydraulic collet assembly 20 elastically deforms them radially inwardly into a gripping position.

When the gripping jaws 300a are in their released position, they preferably define a work-piece-abutting surface that is generally concentric with the axis 80. The work-piece-abutting surface is preferably designed with a small enough tolerance that insertion of a predetermined work piece into the released collet 300 will tend to center the work piece in the collet 300 and assembly 10 against the work-piece abutting surface of the gripping jaws 300a.

While the gripping jaws 300a of the collet 300 are integrally formed with the collet 300, the gripping jaws may alternatively comprise discrete segments that connect to each other (e.g., via a connecting ring) with springs disposed between adjacent jaws to bias the jaws away from each other and into their released positions.

Radially extending bores 400 are formed in the housing 40 radially outwardly of each gripping jaw 300a. Plugs 410 seal the outer ends of the bores 400 to define hydraulic cylinders. Pistons 420 sealingly mate with the bores 400 to define hydraulic chambers 430 therebetween. The hydraulic chambers 430 fluidly connect to the chamber 150 via the passages 160 such that the piston/cylinder 90/70 acts as a master piston/cylinder and each piston/cylinder 420, 400 acts as a slave piston/cylinder. As shown in FIG. 2, one or more Belleville springs 440 operatively extend between each piston 420 and shoulders in the bores 400 in the housing 40 to bias the pistons 420 radially outwardly. Radially Inward ends of the pistons 420 abut outer ends of the gripping jaws 300a directly or indirectly.

The relative positions of the pistons 420 and cylinders 400 could be switched such that the pistons 420 remained in a fixed radial position relative to the housing 40 while the cylinders 400 radially move to actuate the gripping jaws 300a.

The hydraulic collet assembly 20 is dead length in that the gripping jaws 300a do not move axially as they extend between their gripping and released position. The dead length feature facilitates accurate axial positioning of work pieces in the hydraulic collet assembly 20.

Hereinafter, operation of the hydraulic workholding assembly 10 is described with reference to FIGS. 1 and 2. When the draw bar 110 and piston 90 are moved into their open position (to the left as shown in FIGS. 1, 2, and 6) by the closer assembly 120, the collet 300 is naturally disposed in its open/released position. A work piece is then inserted into the collet 300. The tolerance between the released-position collet 300 and work piece is preferably small enough to roughly center the work piece in the workholding assembly 10. When the draw bar closer assembly 120 forces the draw bar 110 and piston 90 to move axially forward toward their closed positions (to the right as shown in FIGS. 1 and 2), the piston 90 pressurizes the chamber 150, which applies hydraulic pressure to the slave piston/cylinders 420, 400. The hydraulic pressure drives the pistons 420 radially inwardly, which forces the gripping jaws 300a radially inwardly into their closed/gripping positions to grip a work piece. To release the work piece, the draw bar 110 and piston 90 are slid rearwardly (to the left as shown in FIGS. 1 and 2) to relieve pressure in the chambers 150, 430, which allows the pistons 420 to return to their outward position under the biasing force of the springs 440 and gripping jaws 300a. The gripping jaws 300a of the collet 300 can then return to their outward released positions.

Draw bar closer assemblies such as the illustrated closer assembly 120 typically provide higher closing forces than are desirable to hold fragile work pieces such as bearing races. The relative operating areas of the master piston/cylinder 90/70 and slave piston/cylinders 420, 400 are preferably designed to convert the high force of the closer assembly 120 into a force that is suitable to hold fragile work pieces. For example, if the piston/cylinder 90/70 has an operating area of about 4 square inches (i.e., a round chamber 150 diameter of about 2.25 inches) and the piston/cylinders 420, 400 have an operating area of about ⅕ of a square inch (i.e., a round chamber 430 diameter of about ½ inch), then the radial force applied by each piston 420 will be about 1/20 of the force of the closer assembly 120 (ignoring friction and other losses). The hydraulic workholding assembly 10 may therefore be used to grip delicate work pieces despite the relatively high closing force applied by the closer assembly 120. The hydraulic workholding assembly 10 may also eliminate a need to reduce a draw bar force applied by the draw bar 110 to grip a fragile work piece. Such a feature is advantageous when the draw bar force is difficult to adjust or when reducing the draw bar force adversely impacts the performance of the draw bar (e.g., by slowing the cycling time of the draw bar).

Conversely, the relative operating areas of the master piston/cylinder 90/70 and slave piston/cylinders 420, 400 may be designed to amplify the force of the closer assembly 120 by giving the piston/cylinders 420, 400 a larger operating area than the master piston/cylinder 90/70. Such an embodiment could be used in connection with a closer assembly and draw bar that provides insufficient closing force.

When designing the assembly 10 such that the gripping jaws 300a each apply a predetermined force to the work piece, the stiffness of the gripping jaws 300a should be considered, as the gripping jaws 300a will resist bending inwardly toward their gripping position. As the radial thickness of the gripping jaws 300a increases in the vicinity of the point where the gripping jaws 300a bend relative to the remainder of the collet 300, the stiffness increases, which reduces a force that the gripping jaws 300a transfer from their pistons 420 to the work piece.

Similarly, the axial placement of the piston/cylinders 420, 400 relative to the bending points of the gripping jaws 300a and the axial position along the gripping jaws 300a that grip the work piece should be taken into consideration, as it affects the length of the moment arm that the piston/cylinders 420, 400 act through, thereby increasing or decreasing the force that the gripping jaws 300a transfer from the piston/cylinders 420, 400 to the work piece. For example, as shown in the embodiment illustrated in FIGS. 1 and 2, the piston/cylinders 420, 400 are generally axially disposed between the point where the gripping jaws 300a bend and the point where the gripping jaws 300a grip a work piece. Consequently, the relative moment arms formed between (a) the bending point and the piston/cylinders 420, 400, and (b) the bending point and the point where the gripping jaws 300a grip the work piece will reduce a force that the gripping jaws 300a transfer from the piston/cylinders 420, 400 to the work piece.

In the illustrated embodiment, slave piston/cylinders 420, 400 are used to actuate the gripping jaws 300a. However, alternative slave variable-volume fluid chambers may alternatively be used to actuate the gripping jaws 300a without deviating from the scope of the present invention. For example, a bladder may be disposed in the housing 40 in place of a piston/cylinder 420, 400. The bladder fluidly connects to the chamber 150 so that the bladder expands when the chamber 150 is compressed. The bladder may press directly against its adjacent gripping jaw 300a, or may actuate the gripping jaw via an intermediate nose or connector. Alternatively, each piston/cylinder 420, 400 may be replaced by a slave fluid chamber having a deformable diaphragm disposed at its inner radial end. The slave fluid chamber fluidly connects to the chamber 150 such that compression of the chamber 150 pressurizes the slave fluid chamber and deforms the diaphragm radially inwardly toward its adjacent gripping jaw 300a, thereby urging the gripping jaw 300a toward its gripping position.

The hydraulic workholding assembly 10 may be used to true out-of-round work pieces. The fluidly-interconnected piston/cylinders 420, 400 cause each piston 420 and associated gripping jaw 300a to apply a substantially equal radial force to the work piece regardless of the radial position of the gripping jaw 300a. Accordingly, the collet 300 applies about equal force to a large-diameter portion of an out-of-round work piece and to a relatively small-diameter portion of the work piece. The gripping jaws 300a extend radially inwardly different amounts to conform to irregularities in the diameter of the out-of-round work piece. Consequently, each gripping jaw 300a tends to firmly grip the work piece without elastically forcing the work piece into a round shape. With the undeformed work piece firmly gripped in the workholding assembly 10, the work piece can be machined into a true round shape to a desired tolerance. Because the workholding assembly 10 does not deform the work piece, the work piece remains in the true round shape even after it is released from the assembly 10.

While the illustrated hydraulic workholding assembly 10 utilizes a push-to-close configuration (i.e., the draw bar 110 pushes the piston 90 forward to close the collet 300), the workholding assembly 10 may alternatively utilize a pull-to-close configuration without deviating from the scope of the present invention. For example, the chamber 150 could be disposed rearwardly of a portion of the piston 90 such that rearward movement of the piston would pressurize the chamber.

While the illustrated hydraulic collet assembly 20 is designed to grip a substantially round work piece, the hydraulic collet assembly 20 may alternatively be designed to grip work pieces that have any other geometric shape (e.g., oval, rectangle, irregular curve, polygon, hexagon, etc.). For example, the inside of the gripping jaws 300a may be formed such that the inside of the collet 300 has a square shape to hold a square work piece. In the embodiment illustrated in FIGS. 1 and 2, axes 450 of the piston/cylinders 420, 400 are radially oriented such that they intersect the axis 80. However, the orientations of the axes 450 could be altered to such that they are perpendicular to a surface of a predetermined work piece at a position that intersects the axis 450. For example, if a rectangular cross-sectioned work piece is to be held, the axes 450 of two of the piston/cylinders 420, 400 that apply force to a long side of the rectangle may be parallel to each other and perpendicular to the long side of the rectangular cross-section. In such an embodiment, it is possible that neither of the axes would intersect the axis 80.

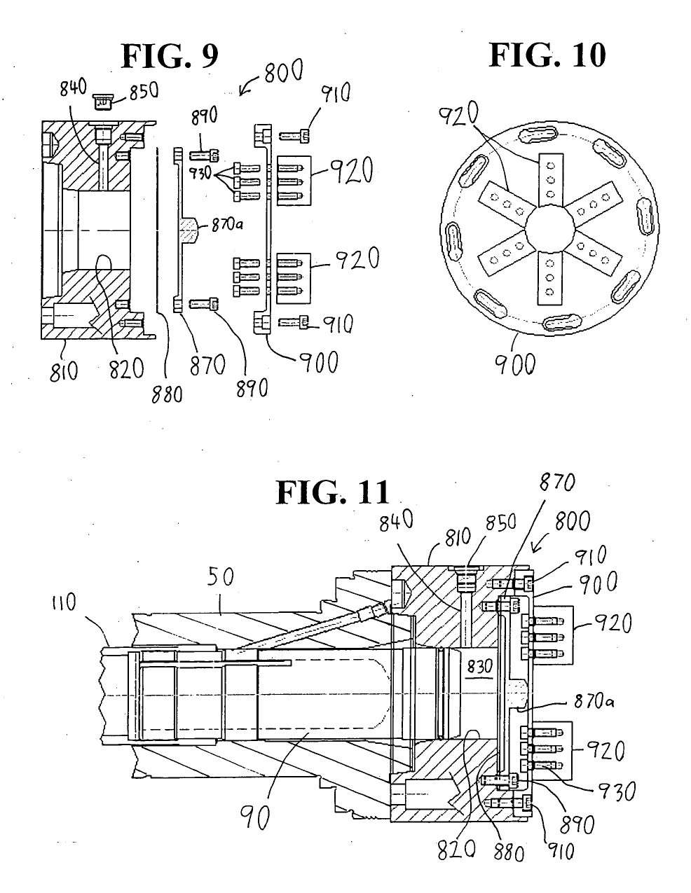

While the illustrated hydraulic collet assembly 20 grips an outside diameter of a work piece, a hydraulic collet assembly according to an embodiment of the present invention could alternatively grip an inside diameter of a work piece. For example, FIGS. 4, 5, 7 and 8 illustrate an inside diameter gripping hydraulic collet assembly 500 that may be used in place of the above-described hydraulic collet assembly 20. As shown in FIGS. 4 and 7, a housing 510 includes radially-extending slave cylinder bores 520 into which slave pistons 530 sealingly slide. As shown in FIG. 7, a hydraulic chamber 540 is formed between each bore 520 and piston 530 radially inwardly from the piston 530. A plug/cap 550 seals the outer radial end of the bore 520. Belleville spring(s) 560 extend between the plug 550 and piston 530 to bias the piston 530 radially inwardly. As shown in FIGS. 7 and 8, a sealing pin 570 having a smaller diameter than the piston 530 extends radially inwardly from the piston 530 to seal a radially-inward end of the chamber 540 defined by an inner bore 580 in the housing 510. 0-rings 600 are provided on the piston 530 and sealing pin 570 to seal them against the bores 520, 580, respectively. A collet closer pin 610 with a T-shaped head 620 extends radially inwardly from the sealing pin 570. In the illustrated embodiment, the piston 530, sealing pin 570, closer pin 610 and head 620 are integrally formed, but may alternatively comprise discrete components that are otherwise fastened together.

As shown in FIG. 4, an inside-diameter-gripping collet 630 mounts to the housing 510. The collet 630 includes a plurality of gripping jaws 630a that are naturally biased radially inwardly toward a released position. As shown in FIG. 5A, an through bore 640 that is elongated in the axial direction of the assembly 10 is formed in each gripping jaw 630a to enable the head 620 of a corresponding closer pin 610 to extend therethrough when the elongated portion of the head 620 is oriented in the axial direction of the workholding assembly 10. A circumferentially-extending slot 650 is formed on an inner radial side of the gripping jaw 630a and is aligned with the bore 640.

Connection of the collet 630 to the hydraulic collet assembly 500 is described with reference to FIGS. 5A-5D. After draining the assembly 500 of hydraulic fluid, the plugs 550 are removed. An operator then pushes or pulls the pistons 530 radially outwardly so that the heads 620 do not extend into the collet-receiving bore in the housing 510. As shown in FIG. 5A, with the pistons 420 in radially outward positions, the collet 630 is slid into position in the housing 510. As shown in FIG. 5B, the pistons 420 are then extended radially inwardly with the elongated direction of the heads 620 aligned with the elongated direction of the bores 640 until the heads 620 extend completely through the bores 640. As shown in FIG. 5C, the heads 620 are then rotated 90 degrees so that the elongated direction of the heads 620 extend in a circumferential direction that aligns with the slots 650. Outer radial ends of the pistons 530 may include surface features (e.g., flat-head slot, Philips head pattern) so that the operator can use a corresponding tool (such as a screw driver) to rotate the pistons 530. As shown in FIG. 5D, the heads 620 are then pulled or pushed radially outwardly until they extend into the slots 650 and abut shoulders formed in the housing 510 at the outer radial end of the slots 650. The plugs 550 are then replaced and the assembly 500 is filled with hydraulic fluid. The collet 630 can be removed from the hydraulic collet assembly 500 by reversing these steps.

According to an alternative embodiment of the present invention, the plugs 550 are not removed during connection and disconnection of the collet 630. Instead, the piston 90 is axially moved to move the pistons 530 inwardly and outwardly as needed.

During operation of the hydraulic collet assembly 500, the draw bar 110 and piston 90 apply hydraulic pressure to the chambers 540, which pushes the pistons 530 radially outwardly. Outward radial movement of the pistons 530 causes the heads 620 to force the gripping jaws 630a radially outwardly into their gripping positions.

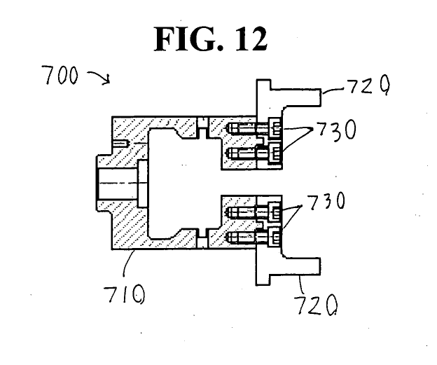

In the embodiment illustrated in FIGS. 4-5, the entire collet 630 is exchanged with another collet 630 to facilitate the gripping of a work piece having a differently shaped or sized inside diameter. However, according to an alternative embodiment of the present invention, as shown in FIG. 12, a multi-piece collet 700 may replace the collet 630. The multi-piece collet comprises a collet portion 710 and discrete gripping jaws 720 that fasten onto forwardly-extending collet fingers/segments of the collet portion 710 via bolts 730 or other suitable fasteners (e.g., screws, etc.). The collet portion 710 is generally similar to the collet 630, and mounts to the housing 510 and pistons 530 in the same (or similar) manner as the collet 630.

To change the inside gripping diameter of the collet 700, an operator unbolts the gripping jaws 720 and replaces them with different gripping jaws that create a different gripping diameter (e.g., gripping jaws that have a different length between the holes for the bolts 730 and an outer radial gripping surface). The collet portion 710 remains attached to the housing 510 and each of its fingers/segments remain attached to their respective pistons 530 when the gripping diameter of the collet 700 is changed.

According to an alternative embodiment of the present invention, slave piston/cylinders are disposed radially inwardly from the gripping jaws of an inside-diameter-gripping collet such that the slave piston/cylinders push the gripping jaws radially outwardly, as opposed to pulling the jaws 630a radially outwardly as shown in FIGS. 4 and 5.

While the illustrated hydraulic workholding assembly 10 applies hydraulic pressure to move the collet 300, 630 into its gripping position, a hydraulic workholding assembly according to the present invention could alternatively include a failsafe configuration in which hydraulic pressure is used to move a collet into its released position and the collet is urged into its gripping position in the absence of such hydraulic pressure.

The hydraulic collet assembly 20 may be replaced by any other type of hydraulic gripping assembly. For example, as shown in FIGS. 9-11, the hydraulic collet assembly 20 and frame 40 is replaced with a hydraulic diaphragm gripping assembly 800 and frame 810. As shown in FIG. 11, the frame 810 includes a bore/cylinder 820 that is constructed and shaped to slidingly mate with the piston 90 to define a hydraulic chamber 830. A radially-extending bore 840 extends from an exterior of the frame 810 to the chamber 830 to facilitate filling the chamber 830 with hydraulic fluid. A plug 850 seals the exterior end of the bore 840.

An axially-flexible actuating diaphragm 870 sealingly mounts to a front end of the frame 810 via a gasket 880 and bolts 890 to seal a forward end of the bore 820 and chamber 830. The actuating diaphragm 870 includes a protrusion 870a that extends forward from the middle of the diaphragm 870.

The actuating diaphragm 870 may be replaced by an actuating piston that slides axially relative to the frame 810 and fluidly seals against the chamber 830. The relative diameters of the piston 90 and actuating piston may be chosen to amplify or reduce the force provided by the draw bar 110.

An axially-flexible diaphragm 900 releasably mounts to the front of the frame 810 in front of the actuating diaphragm via bolts 910 or other fasteners (e.g., screws, nuts, threaded fasteners, etc.). Gripping jaws 920 circumferentially mount to a front side of the collet 900 via bolts 930.

As shown in FIG. 10, the diaphragm 900 is a quick-change collet that allows the collet 900 to be connected and disconnected from the frame 810 without completely removing the bolts 910. Instead, to remove the collet 900 from the housing 810, an operator loosens the bolts 910. The operator then rotates the diaphragm 900 slightly until the heads of the bolts 910 align with large holes in the diaphragm 900. The operator can then pull the collet 900 axially away from the frame 810 and replace it with a collet 900 having a different gripping diameter. Collets 900 can be replaced without affecting the hydraulic fluid in the chamber 830 because the actuating diaphragm seals the chamber 830.

As shown in FIG. 11, when the piston 90 is in an open position (to the left as shown in FIG. 11), the diaphragms 870, 900 are disposed in their unstressed positions, which dispose the gripping jaws 920 in their closed, gripping position to grip an outside diameter of a work piece. To open the collet 900, an operator causes the piston 90 to move to its open position (to the right as shown in FIG. 11), which causes hydraulic pressure to deform the middle of the actuating diaphragm 870 forwardly (to the right as shown in FIG. 11). The protrusion 870a, in turn deforms the middle portion of the collet 900 forwardly, which radially separates the gripping jaws 920, thereby releasing the outside diameter of the work piece. A new work piece can then be inserted into the collet 900. When the piston 90 relieves the hydraulic pressure in the chamber 830, the diaphragm 900 is urged back toward its unstressed position, which causes the gripping jaws 920 to grip the work piece. The diaphragm gripping assembly 800 therefore acts as a failsafe collet in that the collet assembly 800 securely grips a work piece in the absence of hydraulic pressure.

The actuator diaphragms 870, 900 are preferably designed to safely withstand the stresses and strains imparted on them by operation of the draw bar closer assembly 120 and hydraulic diaphragm gripping assembly 800. To ensure that the diaphragms 870, 900 are not overstressed, a feedback loop may be used to limit the hydraulic pressure applied to the diaphragms 870, 900. For example, a strain gauge may be attached to one or both of the diaphragms 870, 900. A servo valve may be incorporated into the hydraulic circuit of the draw bar closer assembly 120 to selectively limit the force of the draw bar 90. A control circuit operatively connects the strain gauge to the servo valve such that the control circuit partially closes the servo valve to reduce the draw bar 90 force if a sensed strain on the associated diaphragm exceeds a predetermined value. The predetermined value is preferably well below a failure strain of the associated diaphragm and may include an additional factor of safety. Consequently, the control circuit tends to ensure that an excessively large draw bar 90 force does not break the hydraulic diaphragm gripping assembly 800.

A control loop could also be incorporated into the assembly 10 (see FIGS. 1-2) by attaching one or more strain gauges to the housing 40 or collet 300 (for example, at the point on the collet where the gripping jaws 300a bend relative to the remainder of the collet 300). If the strain gauge is disposed on the collet 300, electrical contact points may be disposed on the collet and surrounding housing 40 to transmit the strain gauge's resistance to a suitable meter (wired or wireless). A wireless strain gauge may be used to simplify the connection of the strain gauge to the control circuit.

The control circuit may additionally or alternatively be used to select and apply a substantially constant gripping force to the work piece. The strain gauge is preferably disposed close to where the gripping jaws grip a work piece. Consequently, the strain gauge may measure the actual gripping force more accurately than conventional gripping-force-measuring devices that rely on measurements of draw bar 90 force to calculate the gripping force. The control circuit may allow the operator to input the desired clamping force. The control circuit operatively connects to the draw bar closer assembly 120 to control the force applied by the draw bar 90. The control circuit compares the desired clamping force to the sensed strain to calculate whether to apply greater or less draw bar 90 force. The control circuit can thereby cause the assembly 10, 500, 800 to apply a substantially constant, preselected gripping force to a work piece, despite changes in outside variables (e.g., change in the viscosity of the hydraulic fluid due to heat, leaks in the hydraulic circuit of the assembly 10, 500, 800, changes in friction within the assembly 10, 500, 800 or closer assembly 120, variations between different machines 60 having closers 120 that apply different draw bar 90 forces, etc.). Use of the control circuit may therefore reduce damage to and/or adverse deformation of the work piece due to excessive gripping force, while ensuring that the gripping force is sufficiently large to securely grip the work piece.

According to an alternative embodiment of the present invention, the strain gauge is replaced by a pressure sensor that fluidly connects to the hydraulic circuit of any of the assemblies 10, 500, 800 to sense an internal hydraulic circuit pressure that is proportional to a gripping force of the assembly 10, 500, 800. The pressure sensor may transmit a sensed pressure to the control circuit via any suitable mechanism (e.g., mechanical connection, wired electrical connection, wireless connection, etc.).

While the illustrated gripping force sensors are strain gauges or pressure sensors, any other suitable mechanism for measuring a gripping force of the gripping jaws may alternatively be used without deviating from the scope of the present invention (e.g., spring scales, etc.).

While the illustrated diaphragm gripping assembly 800 grips an outside diameter of a work piece, a diaphragm gripping assembly 800 according to an alternative embodiment of the present invention could grip an inside diameter of a work piece. Such a collet assembly could be very similar to the illustrated assembly 800. However, instead of using inner radial sides of the gripping jaws 920 to grip an outer diameter of a work piece, the collet assembly could use the outer radial sides of the gripping jaws 920 to grip an inner diameter of a work piece. If used in the configuration shown in FIG. 11, the collet assembly would grip an inside diameter of the work piece when the piston 90 moves to the right and generates hydraulic pressure. Conversely, the collet would release a work piece when the hydraulic pressure was released and the diaphragms allowed to return to their unstressed position.

The position and size of the protrusion 870a may be modified in various ways tailor its interaction with the diaphragm 900 and gripping jaws 920. For example, the protrusion 870a could be disposed eccentrically on the actuating diaphragm 870, for example to create an eccentric force to open and close gripping jaws that are disposed eccentrically on a diaphragm. The diameter of the protrusion 870a could be increased such that its outer circumference aligns with the inner gripping edges of the jaws 920 to more directly act on the jaws 920. Alternatively, the single protrusion 870a may be replaced with a plurality of protrusions that are arranged, for example, in a circumferentially spaced pattern. A protrusion may be provided for each of the six gripping jaws 920.

In the illustrated embodiments, hydraulic fluid is used as the operating fluid for the hydraulic circuits in the assembly 10. However, any other suitable operating fluid may be used instead (e.g., oil, grease, air, other liquids or gases, etc.). While the operating fluid is preferably incompressible, compressible fluids may alternatively be used without deviating from the scope of the present invention.

In above-described embodiments, the hydraulic pressure generator 30 is used in conjunction with three different types of hydraulic gripping assemblies (i.e., a piston-based outside-diameter-gripping hydraulic collet assembly 20, a piston-based inside-diameter-gripping hydraulic collet assembly 500, or a diaphragm-based hydraulic gripping assembly 800). However, the hydraulic pressure generator 30 may alternatively be used with any other hydraulic gripping assembly without deviating from the scope of the present invention (e.g., bladder-based hydraulic collet assembly, hydraulic chuck assembly, etc.).

The foregoing description is included to illustrate the operation of the preferred embodiments and is not meant to limit the scope of the invention. To the contrary, those skilled in the art should appreciate that varieties may be constructed and employed without departing from the scope of the invention, aspects of which are recited by the claims appended hereto.

1. A workholding assembly for releasably holding a work piece, the assembly comprising
a variable-volume fluid chamber constructed and shaped to detachably mount to an axially-movable draw bar of a machine such that axial movement of the draw bar in a predetermined direction reduces a volume of the variable-volume fluid chamber; and
a fluid-driven gripping assembly comprising
a housing, and
a plurality of circumferentially-spaced slave piston/cylinders supported by the housing each of the slave piston/cylinders having a slave chamber that fluidly connects to the variable-volume fluid chamber such that changes in the volume of the variable-volume fluid chamber operates the plurality of circumferentially-spaced slave piston/cylinders.

2. The workholding assembly of claim 1, further comprising an axially-movable element having a threaded portion that is constructed and arranged to engage a mating threaded portion of the axially-movable draw bar, wherein axial movement of the axially-movable element in the predetermined direction reduces a volume of the variable-volume fluid chamber.

3. (canceled)

4. The workholding assembly of claim 1, further comprising:
a machine; and
a draw bar that is selectively axially movable relative to the machine, wherein the variable-volume fluid chamber is positioned relative to the machine and the draw bar such that axial movement of the draw bar in the predetermined direction reduces the volume of the variable-volume fluid chamber,
wherein the fluid-driven gripping assembly comprises a fluid-driven collet assembly that includes a collet having a collet axis that is coaxial with an axis of the draw bar.
wherein operation of the circumferentially-spaced slave piston/cylinders in a predetermined direction operates the collet.

5. The workholding assembly of claim 1, further comprising:
a machine; and
a draw bar that is selectively axially movable relative to the machine, wherein the variable-volume fluid chamber is operatively disposed between the machine and the draw bar such that axial movement of the draw bar in the predetermined direction reduces the volume of the variable-volume fluid chamber.

6. The workholding assembly of claim 5, wherein:
the draw bar includes a threaded portion;
the workholding assembly further comprises an axially-movable element having a threaded portion that threadingly engages the threaded portion of the draw bar; and
axial movement of the axially-movable element in the predetermined direction reduces a volume of the variable-volume fluid chamber.

7. The workholding assembly of claim 1, further comprising:
a master cylinder;
a master piston slidably engaged with the master cylinder to define the variable-volume fluid chamber, the master piston and master cylinder having a master axis; and
wherein one of the master cylinder and the master piston is constructed and arranged to mount to the machine, and
wherein the other of the master cylinder and the master piston is constructed and arranged to detachably mount to the draw bar.

8. The workholding assembly of claim 7, wherein the fluid-driven gripping assembly mounts to the one of the cylinder and the piston, and wherein the variable-volume fluid chamber fluidly connects to the plurality of circumferentially-spaced slave piston/cylinders such that axial movement of the master piston relative to the master cylinder operates the fluid-driven gripping assembly.

9. (canceled)

10. The workholding assembly of claim 7, wherein each of the slave piston/cylinders has a slave cylinder axis that is perpendicular to the master cylinder axis.

11. The workholding assembly of claim 10, wherein a cross-sectional area of each slave piston/cylinder is smaller than a cross-sectional area of the master cylinder such that a force generated by each slave piston/cylinder is smaller than a force that the draw bar applies to the other of the master cylinder and the master piston.

12. The workholding assembly of claim 10, wherein the fluid-driven gripping assembly comprises a fluid-driven collet assembly, and wherein the fluid-driven collet assembly comprises a collet mounted to the housing, the collet having a plurality of gripping jaws, each gripping jaw being aligned with a corresponding one of the plurality of slave piston/cylinders such that operation of the slave/piston cylinders moves the gripping jaws.

13. The workholding assembly of claim 12, wherein the plurality of gripping jaws are biased toward a released position in which the gripping jaws form a work piece abutting surface that is concentric with the axis.

14. The workholding assembly of claim 13, wherein the work piece abutting surface is shaped to have a tight tolerance with the work piece such that inserting the work piece into the released-position collet tends to center the work piece in the collet.

15. The workholding assembly of claim 8, wherein the fluid-driven collet assembly is constructed and shaped to grip an outside diameter of a work piece.

16. The workholding assembly of claim 8, wherein the fluid-driven gripping assembly is constructed and shaped to grip an inside diameter of a work piece.

17. (canceled)

18. The workholding assembly of claim 8, further comprising:
a machine, wherein the one of the master cylinder and the master piston is mounted to the machine; and
a draw bar that is selectively axially movable relative to the machine, wherein the other of the master cylinder and the master piston is mounted to the draw bar for axial movement with the draw bar relative to the machine.

19. The workholding assembly of claim 7, wherein the other of the master cylinder and the master piston includes a threaded portion that is constructed and arranged to engage a mating threaded portion of the axially-movable draw bar, wherein axial movement of the axially-movable element in the predetermined direction reduces a volume of the variable-volume fluid chamber.

20. A fluid-driven collet assembly comprising:
a housing;
a plurality of circumferentially-spaced piston/cylinders supported by the housing, each of the piston/cylinders having a chamber that is constructed and shaped to fluidly connect to a pressurized fluid source; and
a collet mounted to the housing, the collet having a plurality of gripping jaws, each gripping jaw being aligned with a corresponding one of the plurality of piston/cylinders such that operation of the piston/cylinders moves the gripping jaws.

21. The fluid-driven collet assembly of claim 20, wherein the plurality of gripping jaws are biased toward a released position in which the gripping jaws form a work piece abutting surface that is concentric with the axis.

22. The fluid-driven collet assembly of claim 21, wherein the work piece abutting surface is shaped to have a tight tolerance with the work piece such that inserting the work piece into the released-position collet tends to center the work piece in the collet.

23. The fluid-driven collet assembly of claim 20, wherein the plurality of gripping jaws are integrally formed with each other.

24. A fluid-driven diaphragm gripping assembly comprising:
a housing having a fluid chamber formed therein, the fluid chamber being constructed and shaped to fluidly connect to a source of pressurized fluid;
an actuating element sealingly connecting to the fluid chamber and defining a portion of the fluid chamber, at least a portion of the actuating element being axially movable in response to pressurization of the fluid chamber;
a diaphragm mounted to the housing and operatively connected to the actuating element such that axial movement of the portion of the actuating element deforms the diaphragm;
a plurality of gripping jaws mounted to the diaphragm, wherein deformation of the diaphragm radially separates the gripping jaws from each other.

25. The fluid-driven diaphragm gripping assembly of claim 24, wherein the diaphragm and actuating element may be separated from each other to allow the diaphragm to be detached from the gripping assembly without unsealing the actuating element from the fluid chamber.

26. The fluid-driven diaphragm gripping assembly of claim 25, wherein the diaphragm is mounted to the housing via at least one fastener, and wherein the diaphragm may be detached from the housing without completely detaching the at least one fastener from the housing.

27. A method of operating a fluid-driven workholding assembly comprising a variable-volume fluid chamber and a fluid-driven gripping assembly comprising a housing and a plurality of circumferentially-spaced slave piston/cylinders supported by the housing, each of the slave piston/cylinders having a slave chamber that fluidly connects to the variable-volume fluid chamber such that changes in the volume of the variable-volume fluid chamber operates the plurality of circumferentially-spaced slave piston/cylinders, the method comprising:
detachably mounting the fluid-driven workholding assembly to a machine, the machine having a draw bar that is axially movable relative to the machine along a draw bar axis;
axially moving the draw bar to compress the variable-volume fluid chamber; and
transferring fluid pressure in the variable-volume fluid chamber to the slave piston/cylinders, thereby operating the fluid-driven gripping assembly.

28. The method of claim 27, wherein the fluid-driven gripping assembly has an axis that is coaxial to the draw bar axis.

29. The method of claim 27, wherein transferring fluid pressure comprises applying fluid pressure in the variable-volume fluid chamber to the fluid-driven gripping assembly to close the fluid-driven gripping assembly and grip a work piece.

30. The assembly of claim 1, wherein the variable-volume fluid chamber and the fluid-driven gripping assembly are mounted to each other for mounting as a unit to the machine.

31. The workholding assembly of claim 1, wherein the fluid-driven gripping assembly comprises a fluid-driven collet assembly and wherein the fluid-driven collet assembly comprises a collet mounted to the housing, the collet having a plurality of gripping jaws, each gripping jaw being aligned with a corresponding one of the plurality of slave piston/cylinders such that operation of the slave/piston cylinders moves the gripping laws.

32. The collet assembly of claim 20, wherein each of the piston/cylinders has a cylinder axis that is perpendicular to an axis of the fluid-driven collet assembly
